(19) United States
(12) Patent Application Publication
(10) Pub. No.: US 2004/0234776 A1
(43) Pub. Date: Nov. 25, 2004

(54) Abrasion and oil resistant coating for oil field elastomeric goods

(76) Inventor: Bradford G. Corbett JR., Fort Worth, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 10/776,861

(22) Filed: Feb. 11, 2004

Related U.S. Application Data
(60) Provisional application No. 60/446,615, filed on Feb. 11, 2003.

(51) Int. Cl. B32B 3/02

(52) U.S. Cl. 428/423.1

(57) ABSTRACT

An elastomeric element is shown for use in well bore completion, production and post production operations. The element includes an elastomeric body with an exterior surface. A synthetic, polymeric, polyurethane coating is applied to at least selected portions of the exterior surface of the elastomeric body. The coating provides improved anti-corrosive and anti-friction properties to the body.

### CROSS-REFERENCE TO RELATED APPLICATIONS

The present application claims priority from Provisional Application Ser. No. 60/446,615, filed Feb. 11, 2003, entitled “Abrasion and Oil Resistant Coating for Oil Field Elastomeric Goods”, by the same inventor.

### BACKGROUND OF THE INVENTION

1. Field of the Invention

The present invention relates to surface coatings which provide enhanced performance properties for oil field elastomeric goods and to goods produced with such coatings. The goods are used in drilling, completion, workover, production and post production of oil and gas wells. Specifically preferred coatings are used to provide improved abrasion and oil resistance characteristics for such goods.

2. Description of the Prior Art

A variety of rubber or elastomeric type goods are used in the drilling, completion, workover and production of oil and gas wells. For example, drill bits contain elastomeric O-ring seals and diaphragms which isolate the bit lubricant system from the drilling fluid and cuttings produced during drilling operations. Other sealing applications in the oil and gas industry are required to withstand the high thermal and/or corrosive environment encountered in oil and gas well operations, including natural and/or stimulated flow. Such seals are needed on various well tools such as packers, liner wiper plugs, cementing swab cups and shoes, expansion joints and subs. Presently, the existing elastomer compounds are not satisfactory to meet the requirements in many applications. The existing elastomers do not withstand the in situ environments such as high temperatures, high pressure steam, high pressure corrosive fluids (such as hydrogen sulfide and carbon dioxide), oil and gas, and salt water and associated chemicals, acids and inhibitors introduced. There are various materials that will solve one problem, but not all combinations of problems, depending upon the type of elastomeric member involved and its particular application or end use. In the case of external sealing surfaces, for example, the seals must have the property of being elastic so as to be able to seal off and hold against the encountered pressures, must be strong and rugged enough to withstand physical contact with well members without being torn or ruptured, and must be impervious and resistive to the various well fluids which are encountered.

In order to meet the exacting demands of the oil and gas well environment, the elastomeric members presently utilized for the above purposes are generally formed of exotic elastomeric compounds such SBR, NITRILE and EPDM rubbers and plastics including, for example, those products sold under the tradenames TEFLON, VITON, CALREZ, AFLAS and NORDEL.

Elastomeric goods of the type under consideration are also used in the post-completion/production operations of oil and gas wells. For example, in the operation of pipelines, it periodically becomes necessary to clean accumulations and deposits of sludge, scale, debris, and other material from the inner surfaces of the pipes. These cleaning operations are most commonly carried out by propelling through the pipe, a sphere or other “pig” type device. There are a variety of designs of pigs available, most of which consist generally of a mass of resilient material having a generally circular cross section with a diameter slightly greater than that of the pipe through which they are to be propelled. These pigs are most commonly cylindrical in shape, such as those described in U.S. Pat. Nos. 3,543,323 and 3,277,508. Among other designs for pigs are spheres, described in U.S. Pat. No. 3,543,324, and devices with resilient material mounted upon a rigid central shaft, as described in U.S. Pat. Nos. 3,484,886 and 3,541,628.

Cylindrical pigs can have rounded or pointed forward ends, examples of which are described in U.S. Pat. Nos. 3,538,531 and 3,277,508. Additionally, some pigs are covered with strips of material which are harder than the resilient material of which the pig body is made. Examples of various striping patterns applied to the exterior of pipeline pigs are shown in U.S. Pat. Nos. 3,204,274,3,605,159 and 3,389,417. Spheres or pigs which are useful for purposes of the present invention are thus well known to those in the relevant industry. Pigs suitable for the practice of the present invention are available commercially from Maloney Technical Products, of Fort Worth, Tex., as well as from other sources.

Despite the various improvements which have occurred in materials and manufacturing techniques applied to oil field elastomeric goods, a need exists for a manufacturing technique which will allow the use of traditional elastomeric compounds for the manufacture of elastomeric goods for oil field use.

A need also exists for such a technique which is economical to implement so that elastomeric goods are provided which are abrasion and oil resistant and yet are manufactured from more economical starting materials.

A need also exists for such a technique which can be implemented by spraying a coating on an exposed exterior surface of oil field elastomeric goods to give the goods enhanced performance and endurance characteristics.

### SUMMARY OF THE INVENTION

The present invention is directed to an improved surface coating for oil field elastomeric goods of the type described above which allows a more traditional elastomer to be used for the main body of the goods with the coating providing the overall encapsulated body with abrasion resistance and/or anti-corrosion properties, or other enhanced properties, which goods can be used in a well environment, and which will provide the desired performance characteristics in spite of the adverse environments to which they may be exposed.

In one embodiment, the elastomeric sealing element of the invention is used in downhole well environments. Such articles of manufacture featuring the sealing elements of the invention would include sealing elements for oil field packers, oil field liner wiper plugs, cementing swab cups, shoes, etc. Other articles of manufacture include the sealing elements of oil field rock bits. Post production applications of the articles of the invention include pigging spheres which are used to clean deposits from the interior of oil and gas pipelines.

The preferred sealing elements of the invention include an elastomeric body having an exterior surface which is coated with a synthetic polymeric coating. One preferred coating is a synthetic polymer, preferably thermoplastic, most preferably a polyurethane high performance coating that will withstand severe temperature, chemical attack and abrasion. A particularly preferred coating is manufactured by Lord Chemical Products of Erie, Pa., as the CHEMGLAZE® polyurethane coating. This is a high performance coating that will withstand severe temperature, chemical attack and abrasion. The antifriction and chemical resistant coating can be applied to any technique generally used in the industry and is conveniently applied by spraying on at least selected external surfaces of the elastomeric element followed by a drying period as recommended by the manufacturer.

Another particularly preferred coating is the Lord Elastomeric Coating manufactured by Lord Mechanical Products Division and marketed under the tradename ENDURALAST™ Tire Coating. Additional objects, features and advantages will be apparent in the written description which follows.

### BRIEF DESCRIPTION OF THE DRAWINGS

FIG. 1 is a partial, sectional view of a drill bit showing an O-ring seal and flexible diaphragm which are coated with the coating on the invention.

FIG. 2 is a simplified, schematic view of a well packer employing a coated sealing surface of the invention.

FIG. 3 is a side, partial sectional view of a pipeline pig which is coated with the coating of the invention.

FIG. 4 is a schematic view of a well cementing operation using liner wiper plugs in which the liner wiper plugs are coated with the coating of the invention.

FIG. 4A is a close up view of the region of the cementing tool indicated in FIG. 4 by the dotted lines.

### DETAILED DESCRIPTION OF THE INVENTION

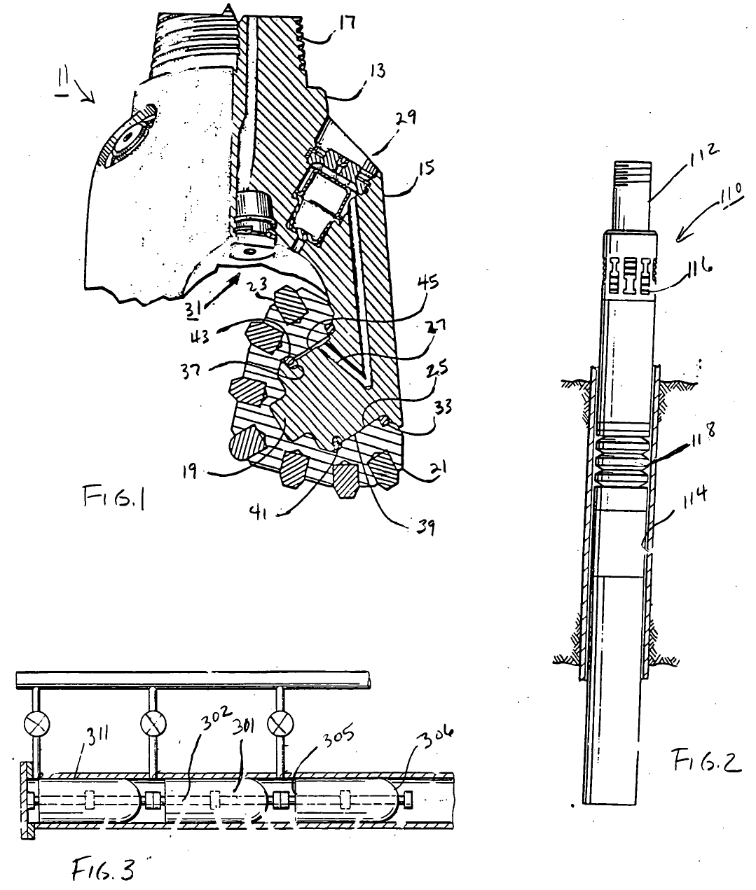

FIG. 1 is a partial, sectional view of an earth boring drill bit 11 which contains sealing elements which are coated with the coating of the invention. The bit 11 includes a body 13 formed of three-head sections 15 that are typically joined by a welding process. Threads 17 are formed on the top of the body 13 for connection to a conventional drill string (not shown). Each head section 15 has a cantilevered shaft for bearing pin 19 having its unsupported end oriented inward and downwardly. A generally conically shaped cutter 21 is rotatably mounted on each bearing pin 19. The cutter 21 has earth disintegrating teeth 23 on its exterior and a central opening or bearing recess 25 in its interior for mounting on the bearing pin 19. Friction bearing means formed on the bearing pin 19 and cutter bearing recess 25 are connected with lubricant passage 27. A pressure compensator (diaphragm) 29 and associated passages constitute a lubricant reservoir that limit the pressure differential between the lubricant and the ambient fluid that surrounds the bit after flowing through the nozzle means 31.

An annular assembly group 37 is formed on the cylindrical surface 39 of the bearing pin 19. A registering retainer groove 41 is formed in the bearing recess 25 of the cutter 21. Grooves 37 and 41 are approximately located so that they register to define an irregularly shaped annular cavity in which is located a snap ring 43. The snap ring 43 preferably has a circular cross-section and is formed of a resilient metal. The ring 43 contains a gap at one circumferential location so that its annular diameter may be compressed or expanded and also so that the lubricant may flow past the ring.

The sealing structure for the bit illustrated in FIG. 1 includes two resilient seal elements, in this case, O-ring 33 located between the bearing pin 19 and cutter 21 at the base of the bearing pin and diaphragm 29. The resilient O-ring 33 and seal region at the base of the bearing pin 19 prevent egress of lubricant and ingress of borehole fluid. Preferably, the O-ring and/or the flexible diaphragm are coated with the external coating of the invention.

One preferred class of materials is sold commercially by Lord Chemical Products of Erie, Pa., as the “Lord Elastomeric Coatings.” These elastomeric coatings have excellent adhesion properties and environmental resistance, and are capable of strains of several hundred percent. It has been found that these coatings may be applied on elastomeric products of the type described to improve appearance, resistance to fluids and resistance to ozone. The coatings can enable a less expensive material to be used in products with characteristics equivalent to more expensive materials. The coatings can be colored as well. These coatings can typically be applied by spraying on at least selected external surfaces of the gasket followed by a drying period as recommended by the manufacturer.

The preferred coating which is applied to the selected surfaces of the elastomeric element is a synthetic polymeric coating. One preferred coating is a synthetic polymer, preferably thermoplastic, most preferably a polyurethane high performance coating that will withstand severe temperature, chemical attack and abrasion. A particularly preferred coating is manufactured by Lord Chemical Products of Erie, Pa., as the CHEMGLAZE® polyurethane coating. This is a high performance coating that will withstand severe temperature, chemical attack and abrasion. The antifriction and chemical resistant coating can be applied to any technique generally used in the industry and is conveniently applied by spraying on at least selected external surfaces of the elastomeric element followed by a drying period as recommended by the manufacturer. The spraying technique can be by conventional air atomized spray coating using a spray gun.

CHEMGLAZE® is an elastomeric polyurethane coating which exhibits inherent flexibility, corrosion resistance and energy absorbing properties. Manufacturers Technical Data for the product is as follows:

| | |
|---|---|
| Mix ratio A/B by volume | 3/1 supplied in premeasured kits |
| Percent solids (by weight) | 56 |
| Volatile Organic compounds | 3.5 lb/gal |
| Tack Free time | 30 min. |

Physical Properties of Cured Coatings:

| Tensile strength ASTM D 412 | 5000 psi |
|---|---|
| Method A, Die C | |
| Percent Elongation | |
| ASTM D 412 Method A, Die C | 500 percent |
| Taber Abraser | |
| CS17 1000 g/1000 cycles | No loss |
| Durometer Shore A | 110 |

Mixing and recommending spray application techniques are given in the manufacturer's REMR Material Data Sheet, CM-SE-1.9.

Another particularly preferred coating is the Lord Elastomeric Coating manufactured by Lord Mechanical Products Division and marketed under the tradename ENDURALAST™ Tire Coating. This product has excellent adhesion properties and environmental resistance and is capable of strains of several hundred percent.

The coatings used in the method of the invention can also have a color additive, such as a suitable pigment, dispersed therein which impart a distinctive color to the coated region of the elastomeric element. Color markings of this type can be used for product identification purposes. Pigments are commercially available from a number of sources such as Cleveland Pigment & Color Co., of Akron, Ohio. These pigments include, by way of example, organic, fluorescent, iron oxide, ultramarine pigments as well as chromium oxide greens and barytes. Another source of pigments is the FDA approved dyes and pigments.

In another embodiment of the invention, the coating of the invention is applied to an improved seal which is used in a well tool for sealing off the space between two well members. While the seal of the present invention may be utilized in many and various types of well tools for use in sealing off the space between two well members, the invention will be illustrated with respect to its use on a well packer for sealing of the annulus between the well casing and well tubing. The coating of the invention can be applied to the outer exposed surface of the seal in order to provide physical protection from damage as the seal is run into the well and/or set. The coating also provides enhanced anti-corrosive properties for the resilient element.

Referring to FIG. 2, the referenced numeral 110 generally indicates any suitable well packer for connection in a well tubing string 112 and within a casing 114 in a well bore. For example, the packer 110 may be a hydraulically set well packer having slip means 116 for setting in the casing 114 and seal means generally indicated by number 118 for packing off the annulus between the tubing 112 and casing 114. Such well packers are conventional and will be familiar to those skilled in the well drilling and completion art.

The preferred embodiment of the sealing assembly 118 is shown in FIG. 2 and includes a plurality of seals each formed of a resilient elastomeric compound coated with the coating of the invention for withstanding the environmental well fluids including high temperature/high pressure steam, high temperature and corrosive produced fluids (hydrogen sulfide and carbon dioxide) and the presence of saltwater. The seal includes an outer layer which encapsulates and protects the inner layers of the seal body and which provides anti-friction and anti-corrosive properties which protect the resilient element from physical abrasion and wear as the packer is moved through and set in the casing 114. The elastomeric resilient body can be formed at least part of a semi-impervious layer such as a plastic and/or asbestos. Suitable plastic materials are sold under the trade names of TEFLON, VITON, CALREZ, AND AFLAS. The resilient elastomeric element is coated with the coating of the invention as previously described. By coating the seal body 118 with the coating of the invention, it is generally possible to use more traditional elastomers for the body without having to resort to the more exotic plastics previously mentioned.

While the individual seals shown in FIG. 2 are shaped in the form of wedges, other suitable forms may be utilized. The elastomeric elements, when coated with the coating of the invention, provide physical strength, protection and chemical protection while still providing a resilient seal which will set and hold the required pressures of a well packer.

Another downhole application for the coated elastomeric members of the invention is for coating the resilient elements used as liner wiper plugs, cementing swab cups, shoes, and sealing elements. Prior art liner cementing equipment includes a flapper or float valve at the bottom of the liner. The flapper is conventionally held open by a breakable tab which is actuated by dropping a ball when the cementing operation is to begin. As the liner is lowered into the well bore, the fluid in front of the liner must be displaced to flow through the bottom opening in the float valve as well as around the outside annulus defined by the well bore and the liner. A typical cementing operation involves the use of a lower liner wiper plug and an upper liner wiper plug. The upper liner wiper plug is initially suspended from the drill string and the lower liner wiper plug is releasably suspended from the upper liner wiper plug. The lower liner wiper plug has at least one and preferably two float valves. Both of these liner wiper plugs are near the top of the tubular member as the tubular member is run into the bore hole. Once the tubular member has been lowered to the required depth and the casing hanger has been set, the lower liner wiper plug is released from the upper liner wiper plug. Once released, the lower plug is pumped down hole by drilling fluid and thus displaces drilling mud from the bore of the tubular member through the large opening in the landing collar at the bottom of the tubular member. The lower liner wiper plug is locked into the landing collar which results in float valves in the lower liner wiper plug being actuated. After cement has been pumped into the tubular member, the upper liner wiper plug is released from the drill string. As the upper liner wiper plug is pumped down, it forces the cement through the float valves, through the opening in the landing collar and into the annulus between the tubular member and the borehole.

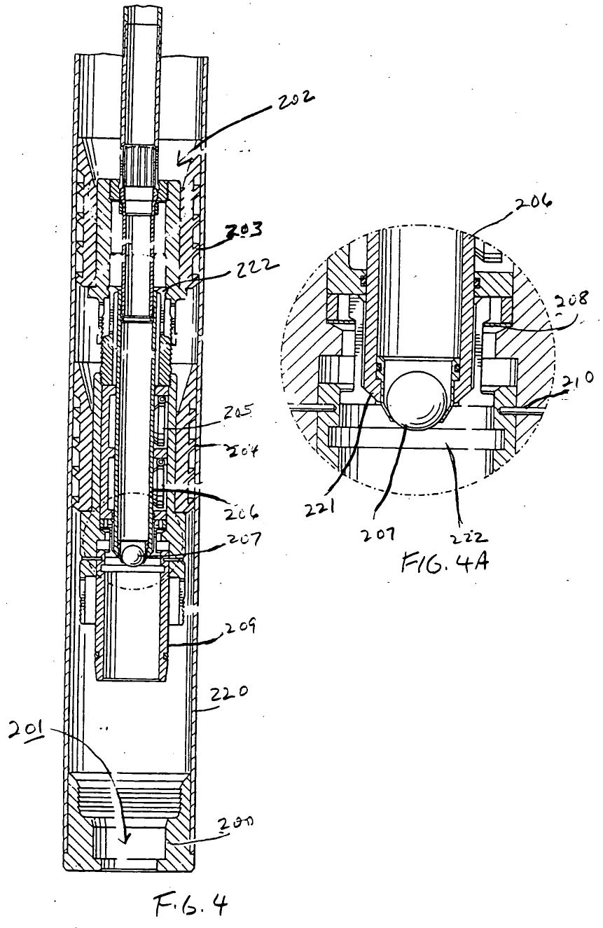

FIGS. 4 and 4A show typical liner wiper plug arrangements including a casing liner 220 with a landing collar 200 which is attached near the bottom of the casing liner 220. The landing collar 200 has an opening 201 there through. The system also includes a wiper assembly 202 which is releaseably suspended from the drilling string. The wiper assembly 202 comprises an upper liner wiper plug 203, which is releasably suspended from the drill string and a lower liner wiper plug 204, which is releasably suspended upper liner wiper plug 203. The lower liner wiper plug 204 comprises at least one float valve 205 and preferably comprises a dual set of float valves 205. During the running in process, the lower liner wiper plug 204 is suspended from an upper plug 203 near the top of the liner 220. The valves 205 are thus located near the top of the liner 220 during running in operation. The valves 205 are held open and protected by tubular sleeve 206.

Once the casing liner has been lowered to full depth and the cementing process is about to begin, a ball 207 is pumped down hole until it lands in a seat in the lower end of the valve opening sleeve 206. The landing ball prevents flow through the valve opening sleeve 206 which allows pressure to be increased above the lower liner wiper plug 204. By increasing pressure behind the ball 207 and above the lower liner wiper plug 204, the washer 208 is forced to deflect. This relatively small deflection allows valve opening sleeve 206 to move downward. The downward movement of valve opening sleeve 206 allows the plurality of fingers 222 to move inward, thereby disengaging themselves from the housing of upper liner wiper plug 203. The lower liner wiper plug 204 is thus released from its connection with the upper liner wiper plug 203.

Once released, the lower liner wiper plug 204 with its associated float valves may be pumped down hole by drilling fluid and thus displaces the drilling mud from the bore of the casing liner 220 through the opening 201 in the landing collar 200 at the bottom of the casing liner and into the well annulus. The lower liner wiper plug 204 is designed so that a protruding nose section 209 seals in a receiving bore in a landing collar located at the lower end of the casing liner 220. The nose section 209 is forced upward in the lower liner wiper plug assembly to break the shear pins 210. This action enables the release of the valve opening sleeve 206, allowing it to move further downward to that the sleeve retainer fingers 221 engage an annular groove. Once the lower liner wiper plug 204 has been pumped down and secured in connection with the landing collar 200 and the float valves 205 have been activated by pumping out the valve opening sleeve 206, the pumping of cement can be completed.

The above description of a typical well cementing operation is intended to convey the general purpose and sealing requirements for the resilient elements which make up the various portions of the cementing system. Each of the well resilient elements such as those on the liner wiper plugs may be formed of an elastomeric body which is coated with the coating of the invention as previously described.

While the above applications of the coated elastomeric bodies of the invention are for down hole use within the well bore, the coated elastomeric bodies of the invention can also be utilized in above ground, post production operations. FIG. 3 illustrates a typical “pigging” operation which, in this case, utilizes a body comprising an oblong mass of polyurethane foam 301 which is bonded to a column member 302. It will be understood that other pigging bodies may be simple spherical bodies. The body 301 has an exterior, exposed surface 311. Body 301 is designed to contact the inner surface of a pipe for the purpose of cleaning the pipe. The body 301 may incorporate features which are generally known in the art with respect to cylindrical pigs. For example, the body may be plain or may be covered with helical strips of material which will impart spin and increase the durability of the pig. Further, the back 305 of the body 301 may be concave and of a flexible fluid impermeable material to transmit a radial component of force caused by fluid pressure to the walls of the pigs. Similarly, the nose 306 of the body may be convex so as to allow the pig to pass obstructions and bends in the pipe more easily. The coating of the invention, as previously described, may be applied to the exterior exposed surface of the pig.

An invention has been provided with several advantages. The coating of the invention can be applied to a variety of elastomeric elements which are used in drilling, production and post production well bore operations. The coating provides improved physical characteristics for the elastomeric goods allowing the main elastomeric body of such elements to be formed of more traditional elastomeric materials. The particularly preferred polyurethane coating provides improved anti-friction and anti-corrosive properties.

While the invention has been shown in one of its forms, it is not thus limited but is susceptible to various changes and modifications without departing from the spirit thereof.

I claim:

1. An elastomeric sealing element used in downhole well environment, the sealing element comprising:
an elastomeric body having an exterior surface;
a synthetic, polymeric, polyurethane surface coating applied to at least selected portions of the exterior surface of the elastomeric body.

2. The elastomeric sealing element of claim 1, wherein the surface coating has the following published characteristics:

| | |
|---|---|
| Mix ratio A/B by volume | 3/1 supplied in pre-measured kits |
| Percent solids (by weight) | 56 |
| Volatile Organic compounds | 3.5 lb/gal |
| Tack Free time | 30 min. |

Physical Properties of Cured Coatings:

| Tensile strength ASTM D 412 | 5000 psi |
|---|---|
| Method A, Die C | |
| Percent Elongation | |
| ASTM D 412 Method A, Die C | 500 percent |
| Taber Abraser | |
| CS17 1000 g/1000 cycles | No loss |
| Durometer Shore A | 110 |

3. The elastomeric sealing element of claim 1, wherein the sealing element is an O-ring seal for a drill bit.

4. The elastomeric sealing element of claim 1, wherein the sealing element is a resilient diaphragm for a drill bit.

5. The elastomeric sealing element of claim 1, wherein the sealing element is a resilient element of an oil field packer.

6. The elastomeric sealing element of claim 1, wherein the sealing element is a resilient element of a liner wiper plug.

7. The elastomeric sealing element of claim 1, wherein the sealing element is a component of a cementing shoe.

8. The elastomeric sealing element of claim 1, wherein the sealing element is a pipeline pig.

9. An elastomeric sealing element used in downhole well environment, the sealing element comprising:
an elastomeric body having an exterior surface;
a synthetic, polymeric surface coating applied to at least selected portions of the exterior surface of the elastomeric body, the synthetic, polymeric surface coating comprising ENDURALAST™ Tire Coating manufactured by Lord Chemical Corporation.
